(19) United States
(12) Patent Application Publication
(10) Pub. No.: US 2026/0319566 A1
(43) Pub. Date: Oct. 15, 2026

(54) POWER AVAILABILITY SIGNALING TO HIGH-POWER ADD-IN CARDS

(71) Applicant: DELL PRODUCTS L.P., Round Rock, TX (US)

(72) Inventors: Jonathan F. Lewis, Round Rock, TX (US); Jason Rock, Austin, TX (US); Timothy M. Lambert, Austin, TX (US); Jeffrey Kennedy, Austin, TX (US)

(21) Appl. No.: 19/176,962

(22) Filed: Apr. 11, 2025

(51) Int. Cl. G06F 1/3234; G06F 13/40

(52) U.S. Cl. CPC G06F 1/325; G06F 13/4068

(57) ABSTRACT

An add-in card includes a control circuit, an input to receive a power regulation signal, and a multiplexor. An input of the multiplexor receives the power regulation signal, a first output is coupled through a debounce circuit to the control circuit, and a second output is coupled to the control circuit. In a first mode of operation, the power regulation signal is switched to the first output, and in a second mode of operation, the power regulation signal is switched to the second output. In the first mode of operation, the add-in card enters a low power state in response to an assertion of the power regulation signal. In the second mode of operation, the add-in card receives power governor information to set a power level of the add-in card at a level within a range of power levels, the range being between the low power state and a maximum power state of the add-in card.

### FIELD OF THE DISCLOSURE

This disclosure relates to information handling systems, and more particularly relates to power availability signaling to high-power add-in cards in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An add-in card may include a control circuit, an input to receive a power regulation signal, and a multiplexor. An input of the multiplexor may receive the power regulation signal, a first output may be coupled through a debounce circuit to the control circuit, and a second output may be coupled to the control circuit. In a first mode of operation, the power regulation signal may be switched to the first output, and in a second mode of operation, the power regulation signal may be switched to the second output. In the first mode of operation, the add-in card may enter a low power state in response to an assertion of the power regulation signal. In the second mode of operation, the add-in card may receive power governor information to set a power level of the add-in card at a level within a range of power levels, the range being between the low power state and a maximum power state of the add-in card.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method for discovery, setup, and operation of an add-in card that supports a Power Governor state according to an embodiment of the present disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

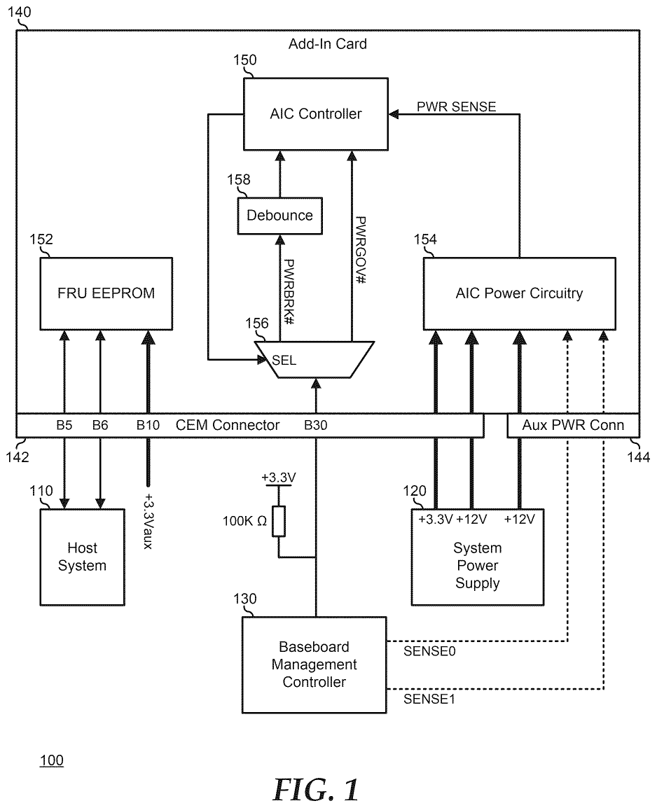

FIG. 1 illustrates an information handling system 100 similar to information handling system 300, as described further below. Information handling system 100 includes a host system 110, a system power supply 120, a baseboard management controller 130, and an add-in card (AIC) 140. Host system 110 represents a main processing environment instantiated on a processor of information handling system 100 that typically includes a Basic Input/Output System/Universal Extensible Firmware Interface (BIOS/UEFI), and an operating system. For the purposes of the current disclosure, host system 110 operates in a pre-OS stage of operation to initialize AIC 140. The initialization of AIC 140 may include setting up a data communication link (not illustrated) between host system 110 and the AIC, setting power conditions on the AIC, such as determining a max power level of the AIC or the like. The details of initializing an AIC in an information handling system are known in the art and will not be further described herein, except as may be needed to illustrate the current embodiments.

System power supply 120 operates to receive electrical power from a power line, such as a 220V or 440V AC power line, and to convert the input power to various power rails as may be needed by the circuitry of information handling system 100. For example, system power supply 120 is illustrated as providing a +3.3 Volt (V) DC power rail, and a +12V power rail. System power supply 120 may provide one or more additional power rail (not illustrated) as needed or desired. The power rails provided by system power supply 120 may be switched or unswitched, as needed or desired. That is, one or more of the power rails may be energized only when information handling system 100 is in a power-on state, and one or more other power rail may be energized even when the information handling system is in a power-off state. The details of system power conversion in a system power supply are known in the art and will not be further described herein, except as may be needed to illustrate the current embodiments.

BMC 130 represents a controller subsystem of information handling system 100 that operates out-of-band from host system 110 to monitor, manage, and maintain the operations of the information handling system. For example, BMC 130 may operate to monitor the thermal conditions of information handling system 100, to manage fan speeds within the information handling system, to control various voltage regulators, such as processor voltage regulators or the like, to maintain various firmware elements of the information handling system, or the like, as needed or desired. The details of the monitoring, managing, and maintaining of the operations of an information handling system by a BMC are known in the art and will not be further described herein, except as may be needed to illustrate the current embodiments.

AIC 140 represents a hardware device that is pluggable into a printed circuit board (PCB) of information handling system 100 to enhance a functionality of the information handling system or to add a new functionality to the information handling system, as needed or desired. As such, AIC 140 may represent a network device like a network interface card (NIC) or a host bus adaptor (HBA), a Universal Serial Bus (USB) expansion card, a firewall expansion card, a storage controller card, a high-end sound or video card, an image capture card, a graphics processor, an artificial intelligence (AI) coprocessor card, a logic device like a Field Programmable Gate Array (FPGA), or another type of device, as needed or desired. As illustrated, AIC 140 represents an AIC that is configured in accordance with a Peripheral Component Interconnect-Express (PCIe) standard, such as a PCI Express Base Specification, Revision 6.x, or the like, as published by the PCI Special Interest Group (PCI-SIG). However, it will be understood that the current embodiments are not meant to be limited to PCIe AICs only, but may find applicability in other types of AICs as needed or desired. In particular, the current embodiments are meant to be applicable to any type of AIC or other type of device that is configured to receive a Power Brake signal (PWRBRK #) as described in a relevant PCI Express Base Specification or a relevant PCI Express Card Electromechanical Specification, as described below. As such, the embodiments described herein are to be understood in their broadest applications.

As illustrated, AIC 140 is configured to be installed into information handling system 100 in accordance with a card electromechanical specification, such as the PCI Express Card Electromechanical Specification, Revision 6.x, or the like, as published by the PCI-SIG. As such, AIC 140 is illustrated as being installed and electrically connected into information handling system 100 via a Card Electromechanical (CEM) connector 142, and an auxiliary power connector (Aux PWR Conn) 144. Here, in a typical configuration, the PCB of information handling system 100 may include a PCIe socket of varying data widths (e.g., a x1, x4, x8, or x16 socket), as needed or desired. In this case, AIC 140 may typically include a card-edge connector that is installed into the PCIe socket to mechanically retain and electrically connect the AIC to information handling system 100. Note that various connections are illustrated herein, but that, for the sake of clarity of illustration, multiple other connections are omitted. As such, it will be understood that CEM connector 142 will include a full CEM connector as specified by the relevant specifications. Further, for the sake of clarity of illustration, both the PCIe socket and the card-edge connector are show as a single element. CEM connector 142 will be understood to be specified to be capable of providing a limited amount of power from the various voltage rails from system power supply 120 (e.g., the +3.3V rail and the +12V rail). However, it is not uncommon for an AIC such as AIC 140 to require additional power from system power supply 120. As such, AIC 140 is illustrated as being connected to system power supply 120 by auxiliary power connector 144, which represents a separate connector, typically via a power whip from the system power supply to a dedicated connector on the AIC. Such a power connection will be understood to be optional as needed or desired. However, as described further below, various embodiments may utilize such a power connection to provide the functionality as described herein.

AIC 140 includes an AIC controller 150, a Field Replaceable Unit (FRU) Electrically Replaceable Read Only Memory (EEPROM) 152, AIC power circuitry 154, a multiplexor 156, and a debounce circuit 158. AIC 140 may be understood to include additional elements as needed or desired, based upon the type of AIC. AIC controller 150 represents hardware and firmware of AIC 140 that is configured to monitor, manage, and maintain the operations of the AIC, as needed or desired. FRU EEPROM 152 represents a non-volatile memory device configured to store FRU data for AIC 140, such as a part number, a serial number, and a manufacturer of the AIC, and other manufacturer data, such as specifications and options that are available on the AIC. AIC power circuitry 154 is configured to receive the power from the connected power rails and to condition the received power to the needs of AIC 140. Additionally, AIC power circuitry 154 is configured to receive various communication signals as described further below. Multiplexor 156 and debounce circuit 158 will be described further below.

Connectivity between information handling system 100 and AIC 140 is illustrated as follows. Host system 110 is connected via pins B5 and B6 of CEM connector 142 to FRU EEPROM 152 to request and receive the FRU data from the FRU EEPROM, and the FRU EEPROM is connected via the B10 pin of the CEM connector to receive an auxiliary power rail (+3.3Vaux) to power the FRU EEPROM. Here, pins B5 and B6 of CEM connector 140 may represent the two signal lanes of a two-wire communication link, such as a SMBus or I2C interface. The +3.3V power rail from system power supply 120 is connected via one or more pin of CEM connector 142 to AIC power circuitry 154, and the +12V power rail from the system power supply is connected via one or more pin of the CEM connector 142 to the AIC power circuitry. An additional +12V power rail from system power supply 120 is connected via one or more pin of auxiliary power connector 144 to AIC power supply 154. Two communication signals (SENSE0 and SENSE1) are connected via associated pins of auxiliary power connector 144 between BMC 130 and AIC power circuitry 154. BMC 130 is connected to an input of multiplexor 158 via pin B30 of CEM connector 142. The communication line between BMC 130 and multiplexor 158 may be provided with a pull-up resistor (e.g. a 100K Ω resistor), as needed or desired.

Connectivity within AIC 140 is illustrated as follows. AIC power circuitry 144 provides a power sense output (PWR SENSE) to AIC controller 150. AIC controller 150 provides a select signal (SEL) to multiplexor 156 to direct the received signal from BMC 140 either to the AIC controller directly as a power governor input (PWRGOV #) or to the AIC via debounce circuit 158 as a power brake input (PWRBRK #) as described further below.

It will be understood that the power brake input (PWRBRK #) is a signal from information handling system 100 to add-in card 140 that has known and predetermined functionality, as defined by the relevant PCI Express Base Specification and the relevant PCI Express CEM specification. In particular, the power brake input (PWRBRK #) represents an emergency signal to instantaneously reduce the power consumption of information handling system 100 by directing the devices that receive the power brake input (PWRBRK #) to immediately reduce the power consumption of the receiving devices to a lowest power setting (typically by entering an Emergency Power Reduction state as specified). The power level associated with the Emergency Power Reduction state is not specified, and is typically set by the manufacturer of the associated AIC. Here, the power brake mechanism as described is intended as an emergency measure to protect the information handling system from catastrophic conditions that may damage the hardware of the information handling system.

When AIC 140 is operating in a power brake mode, AIC controller 150 operates to select the input from BMC 130 to be directed to the AIC controller via debounce circuit 158. Note that debounce circuit 158 and the function thereof is described by the relevant PCI Express Base Specification and the relevant PCI Express CEM specification, and the details of the debounce circuit are thus known in the art and will not be further described herein, except as may be needed to illustrate the current embodiments. Further, the power brake mechanism is specified by the relevant PCI Express Base Specification and the relevant PCI Express CEM specification, and the details of the power brake mechanism, the generation of the power brake signal (PWRBRK #), and the AIC's response to the assertion of the power brake signal (PWRBRK #) are known in the art and will not be further described herein, except as may be needed to illustrate the current embodiments.

It has been understood by the inventors of the current disclosure that there is currently no industry standard method whereby an information handling system signals power consumption variability to add-in cards in order to actively budget power based on workload, or to account for loss of secondary power supplies by limiting the add-in cards' power consumption. That is, it is understood that the application of the power brake mechanism permits only two operating states for add-in cards: an unrestrained high-power state and an emergency low-power state. However, there is no current method for directing an add-in card to operate at a selected intermediate power state.

In a particular embodiment, information handling system 100 implements a Power Governor state for directing add-in card 140 to operate at a predetermined power level during runtime operations on the information handling system. The Power Governor state provides stepwise control over add-in card 140 based on instantaneous system power availability. In this embodiment, the B30 pin of CEM connector 142 is used as a Flex I/O feature in accordance with the relevant PCI Express Base Specification and the relevant PCI Express Card Electromechanical Specification. In particular, this Flex I/O feature ensures that information handling system 100 can operate compatibly with AICs that are not enabled to implement the Power Governor state, but can selectably implement the Power Governor state on AIC 140, as needed or desired. More particularly, when in the Power Governor state, BMC 130 implements a power governor signal (PWRGOV #) on pin B30 of CEM connector 142, as described further below. In this regard, the power governor signal (PWRGOV #) utilizes the same +3.3V signaling and the same biasing (i.e., the pull-up resistor) as the power brake signal (PWRBRK #), and both the PCB of information handling system 100 and AIC 140 utilize the power brake mechanism as a default operating mode, but are both switchable to the Power Governor mode.

Switching to Power Governor mode is initiated by a discovery phase, typically performed during the pre-OS stage of operation on information handling system 100, such as during a Power On Self-Test (POST) for the information handling system. Here, host system 110 operates to query FRU EEPROM 152 to determine whether or not the Power Governor state is supported by AIC 140. As such, FRU EEPROM 152 may include information related to the Power Governor state as implemented by AIC 140, in addition to the information included in the FRU EEPROM as described above. Such additional information may include details as to the power levels supported by AIC 140 in a reduced power state (e.g., 100 Watts (W), 250 W, 500 W), or a range of power levels and an associated power step size (e.g., 100-500 W in 20 W increments).

Once it is determined that AIC 140 supports the Power Governor state, information handling system 100 directs AIC 140 to activate the Power Governor state. Here, for example, host system 110 can direct AIC controller 150 to activate the Power Governor state via communications over a high-speed data communication interface (not illustrated), such as the PCIe data communication links, via a low-speed data communication interface (not illustrated), such as a two-wire interface like a SMBus or I2C interface. In another example, BMC 130 can direct AIC controller 150 to activate the Power Governor state via communications over a low-speed data communication interface. In response to the activation of the Power Governor state, AIC controller 150 selects the power governor signal (PWRGOV #) output of multiplexor 156, thereby connecting BMC 130 directly to the AIC controller, without passing the signal from the BMC through debounce circuit 158.

When the Power Governor state is enabled and operational, the power governor signal (PWRGOV #) becomes a 1-wire, 3.3V Universal Asynchronous Receiver/Transmitter (UART) compatible signal. To set a power level, BMC 130 operates to send a fast UART byte at the start of the power governor signal (PWRGOV #) assertion that encodes the target power level for AIC 140. For example, where the transmitted byte encodes for 20 W increments, the transmitted byte can set the target power level for AIC 140 in the range of 0-5 kW.

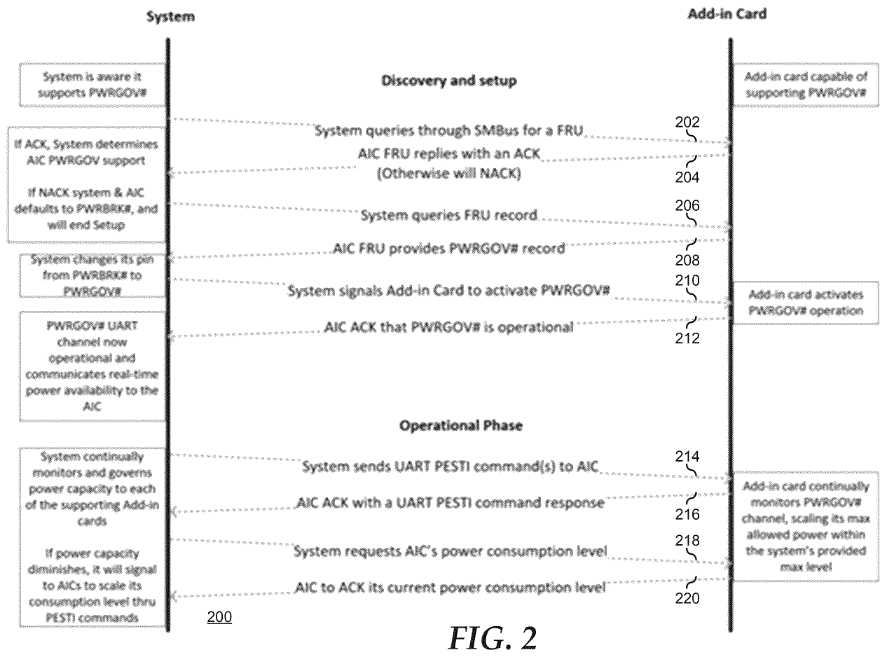

FIG. 2 illustrates a method 200 for discovery, setup, and operation of an AIC that supports the Power Governor state. Here, it is assumed that the information handling system and the AIC both support the Power Governor state. Discovery and setup of the Power Governor state is provided as follows. In a first step 202, the information handling system queries a FRU EEPROM of the AIC, for example, through an SMBus to determine if the AIC supports the Power Governor state. In a next step 204, the FRU EEPROM replies with an acknowledgement (ACK) that the AIC supports the Power Governor state. If the FRU EEPROM responds with a not acknowledged (NACK), then the AIC does not support the Power Governor state, and the system and the AIC both default to the use of the power brake mechanism (PWRBRK #). When the information handling system receives the acknowledgement (ACK), the information handling system queries the FRU EEPROM for the FRU record in step 206, and the FRU EEPROM replies with a record indicating the parameters for the AIC support of the Power Governor state in step 208. The information handling system changes the operation of the power brake signal (PWRBRK #) to the power governor signal (PWRGOV #), and provides a command to the AIC to activate the Power Governor state in step 210. In step 212, the AIC responds with an acknowledgement (ACK) when the Power Governor state is operational.

The operation of the Power governor state is provided as follows. During the operation phase, the information handling system continuously monitors and governs the power level of the information handling system and manages the power levels of the AIC accordingly. For example, when the power level of the information handling system changes, the information handling system may determine that the power level of the AIC may be changed in response. In a particular case, when the overall power consumption of the information handling system decreases, it may be determined that the power consumption of the AIC may be increased, and vice versa. When the power level of the AIC is determined to be changed, the following steps may occur. In a first step 214, the information handling system sends a UART command, such as a Peripheral Sideband Tunneling Interface (PESTI) command to the AIC. Here, because the AIC is in the Power Governor state, the AIC operates to continuously monitor the power governor signal (PWRGOV #), the AIC receives the UART command, and responds with an acknowledgement (ACK) in step 216. In step 218, the information handling system sends a UART command requesting a power consumption level on the AIC, and the AIC provides an acknowledgement (ACK) to the information handling system in step 220.

Returning to FIG. 1, auxiliary power connector 144 represents an additional connector arrangement that is configured to provide additional power to AIC 140, over and above the amount of power that can be handled by the +3.3V and +12V pins of CEM connector 142. This is needed by AICs that require higher power levels. The relevant PCI Express Card Electromechanical Specification specifies a 12V, 2×6 connector that includes four (4) sideband signals, including the SENSE0 and SENSE1 lines. As currently utilized, the SENSE0 and SENSE1 lines are sampled by AIC power circuitry 154 at power up to set initial and maximum permitted power draw of AIC 140, and the SENSE0 and SENSE1 lines are not utilized during runtime.

In a particular embodiment, information handling system 100, such as a BIOS/UEFI or BMC 130, operates to direct AIC 140 to re-task the SENSE0 and SENSE1 lines for runtime utilization to provide out-of-band dynamic target power levels for the AIC 140. In a particular case, the communication is the same as described above for the power governor signal (PWRGOV #). In this case, the signal from BMC 130 may be retained as the power brake signal (PWRBRK #), as needed or desired. Here, AIC controller 150 operates to direct multiplexor 156 to switch the signal from BMC 130 on pin B30 of CEM connector 142 through debounce circuit 158 to the AIC controller. A case may be envisaged where the use of the SENSE0 and SENSE1 signaling during runtime in a Power Governor state obviates the need for the multiplexing of the signal from BMC 130 on pin B30 of CEM connector 142. In this case, multiplexor 156 could be eliminated and the signal from BMC 130 would be routed directly to debounce circuit 158, thereby retaining the power brake mechanism. However, it will be understood that the maximum flexibility of operation of AIC 140 is retained when both the signal multiplexing and the runtime signaling through the SENSE0 and SENSE1 lines are retained on AIC 140.

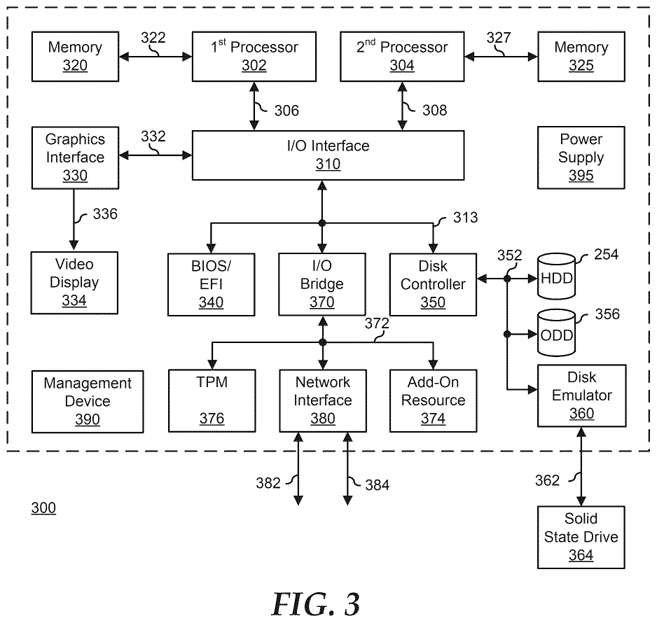

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An add-in card for an information handling system, the add-in card comprising:
a control circuit:
an input to receive a power regulation signal from the information handling system; and
a multiplexor including an input to receive the power regulation signal, a first output coupled through a debounce circuit to the control circuit, and a second output coupled to the control circuit, wherein in a first mode of operation, the power regulation signal is switched to the first output, and in a second mode of operation, the power regulation signal is switched to the second output;
wherein, in the first mode of operation, the add-in card enters a low power state in response to an assertion of the power regulation signal; and
wherein, in the second mode of operation, the add-in card receives power governor information to set a power level of the add-in card at a level within a range of power levels, the range being between the low power state and a maximum power state of the add-in card.

2. The add-in card of claim 1, further comprising:
a non-volatile memory device to store configuration information for the add-in card.

3. The add-in card of claim 2, wherein the configuration information specifies that the add-in card is enabled to operate in the second mode of operation.

4. The add-in card of claim 3, wherein, when the add-in card is powered on, the add-in card defaults to the first mode of operation.

5. The add-in card of claim 4, wherein, when the add-in card is powered on, the add-in card further provides the configuration information to the information handling system.

6. The add-in card of claim 5, further configured to receive a command from the information handling system to enter the second mode of operation in response to providing the configuration information.

7. The add-in card of claim 6, further configured to select the second output in response to receiving the command.

8. The add-in card of claim 1, wherein, when the add-in card is in the first mode of operation, the power regulation signal is a power brake signal (PWRBRK #).

9. The add-in card of claim 1, wherein the power governor information encodes the power level in predetermined increments.

10. The add-in card of claim 1, wherein the add-in card is a Peripheral Component Interconnect-Express (PCIe) add-in card.

11. A method, comprising:
providing, in an information handling system, an add-in card;
providing, on the add-in card, a control circuit:
providing, on the add-in card, an input to receive a power regulation signal from the information handling system;
providing, on the add-in card, a multiplexor including an input to receive the power regulation signal, a first output coupled through a debounce circuit to the control circuit, and a second output coupled to the control circuit, wherein in a first mode of operation, the power regulation signal is switched to the first output, and in a second mode of operation, the power regulation signal is switched to the second output;
entering, in the first mode of operation, the add-in card to a low power state in response to an assertion of the power regulation signal;
receiving, in the second mode of operation, power governor information; and
setting a power level of the add-in card at a level within a range of power levels in response to receiving the power governor information, the range being between the low power state and a maximum power state of the add-in card.

12. The method of claim 11, further comprising:
providing, on the add-in card, a non-volatile memory device to store configuration information for the add-in card.

13. The method of claim 12, wherein the configuration information specifies that the add-in card is enabled to operate in the second mode of operation.

14. The method of claim 13, wherein, when the add-in card is powered on, the add-in card defaults to the first mode of operation.

15. The method of claim 14, wherein, when the add-in card is powered on, the add-in card further provides the configuration information to the information handling system.

16. The method of claim 15, further comprising:
receiving a command from the information handling system to enter the second mode of operation in response to providing the configuration information.

17. The method of claim 16, further comprising:
selecting the second output in response to receiving the command.

18. The method of claim 11, wherein, when the add-in card is in the first mode of operation, the power regulation signal is a power brake signal (PWRBRK #).

19. The method of claim 11, wherein the power governor information encodes the power level in predetermined increments.

20. An information handling system, comprising:
a baseboard management controller configured to provide a power regulation signal; and
an add-in card, including:
a control circuit:
an input to receive the power regulation signal from the infBMC; and
a multiplexor including an input to receive the power regulation signal, a first output coupled through a debounce circuit to the control circuit, and a second output coupled to the control circuit, wherein in a first mode of operation, the power regulation signal is switched to the first output, and in a second mode of operation, the power regulation signal is switched to the second output;
wherein, in the first mode of operation, the add-in card enters a low power state in response to an assertion of the power regulation signal; and
wherein, in the second mode of operation, the add-in card receives power governor information to set a power level of the add-in card at a level within a range of power levels, the range being between the low power state and a maximum power state of the add-in card.
